(19) United States
(12) Patent Application Publication
(10) Pub. No.: US 2013/0008979 A1
(43) Pub. Date: Jan. 10, 2013

(54) ROTATING NOZZLE SYSTEM

(76) Inventor: Hermann LANGE, Metzingen (DE)

(21) Appl. No.: 13/539,938

(22) Filed: Jul. 2, 2012

(30) Foreign Application Priority Data
Jul. 6, 2011 (DE) 102011078725.9

(51) Int. Cl. B05B 1/34

(52) U.S. Cl. 239/380

(57) ABSTRACT

A rotating nozzle system comprising a nozzle head and a first driving system for rotating the nozzle head about a first axis of rotation, in which a second driving system is provided for rotating the nozzle head and the first driving system about a second axis of rotation, wherein the second axis of rotation is disposed substantially at right angles to the first axis of rotation.

### CROSS REFERENCE TO RELATED APPLICATION

This application claims the priority of German Application No. 10 2011 078 725.9, filed Jul. 6, 2011, the disclosure of which is hereby incorporated by reference in its entirety into this application.

### FIELD OF THE INVENTION

The invention relates to a rotating nozzle system comprising a nozzle head and a first driving system for rotating the nozzle head about a first axis of rotation.

### BACKGROUND OF THE INVENTION

Rotating nozzle systems used, for example, as cleaning nozzles are generally known. For example, each of a number of single nozzles releases a solid stream jet providing satisfactory cleaning efficiency. The plurality of single nozzles is then rotated collectively about an axis of rotation by means of a driving system such that a large area can be covered by the single nozzles. Such rotating nozzle systems are used as tank-cleaning nozzles.

### SUMMARY OF THE INVENTION

It is an object of the invention to improve a rotating nozzle system.

To this end, the invention provides a rotating nozzle system comprising a nozzle head and a first driving system for rotating the nozzle head about a first axis of rotation, in which rotating nozzle system there is provided a second driving system for rotating the nozzle head and the first driving system about a second axis of rotation disposed substantially at right angles to the first axis of rotation.

The provision of two driving systems makes it possible to superimpose two rotational movements. A large area to be cleaned can be covered whilst achieving a compact construction of the rotating nozzle system in that the first and second axes of rotation are substantially at right angles to each other.

In a development of the invention, the nozzle head comprises a plurality of solid stream jet nozzles each of which releases a solid stream jet oriented substantially radially relative to the first axis of rotation.

The provision of a plurality of solid stream jet nozzles in a substantially radial arrangement makes it possible to provide a simple, compact construction and satisfactory cleaning efficiency.

In a development of the invention, the first driving system comprises a housing and a turbine wheel disposed in the housing, and the turbine wheel and the nozzle head are non-rotationally connected to a hollow shaft mounted in the housing.

Such a design makes it possible to provide a very compact, gearless construction. Thus the rotating nozzle system, when constructed in the form of a cleaning nozzle, can be introduced into even comparatively small tank inspection holes. The turbine wheel is driven by the relevant cleaning fluid itself, which is again conducive to achieving a construction of simple design.

In a development of the invention, the housing is connected to the second driving system.

In this way, the entire housing is rotated together with the second driving system about the second axis of rotation so that a large area can be covered by the nozzle system in this way.

In a development of the invention, the housing is annular in shape.

The annular shape of the housing allows a compact construction that is easy to produce. More particularly, it is possible to dispose the turbine wheel and mount a hollow shaft non-rotatably connected to the nozzle head and turbine wheel in the housing in a space-saving manner.

Additional features and advantages of the invention are revealed in the claims and the following description of a preferred embodiment of the invention with reference to the drawings.

### BRIEF DESCRIPTION OF THE DRAWINGS

FIG. 1 is a partial cross-sectional side view of a first driving system and a nozzle head for a rotating nozzle system of the invention according to a preferred embodiment;

FIG. 2 is a front view of the first driving system and the nozzle head;

FIG. 3 is a view, taken obliquely from above, of the first driving system for the nozzle head;

FIG. 4 is a view of the cross-sectional plane A-A indicated in FIG. 2;

FIG. 5 is a view, taken obliquely from behind, of the driving system and the nozzle head;

FIG. 6 is an exploded view of the first driving system and the nozzle head shown in FIG. 1; and

FIG. 7 is a side view of the rotating nozzle system of the invention.

### DETAILED DESCRIPTION

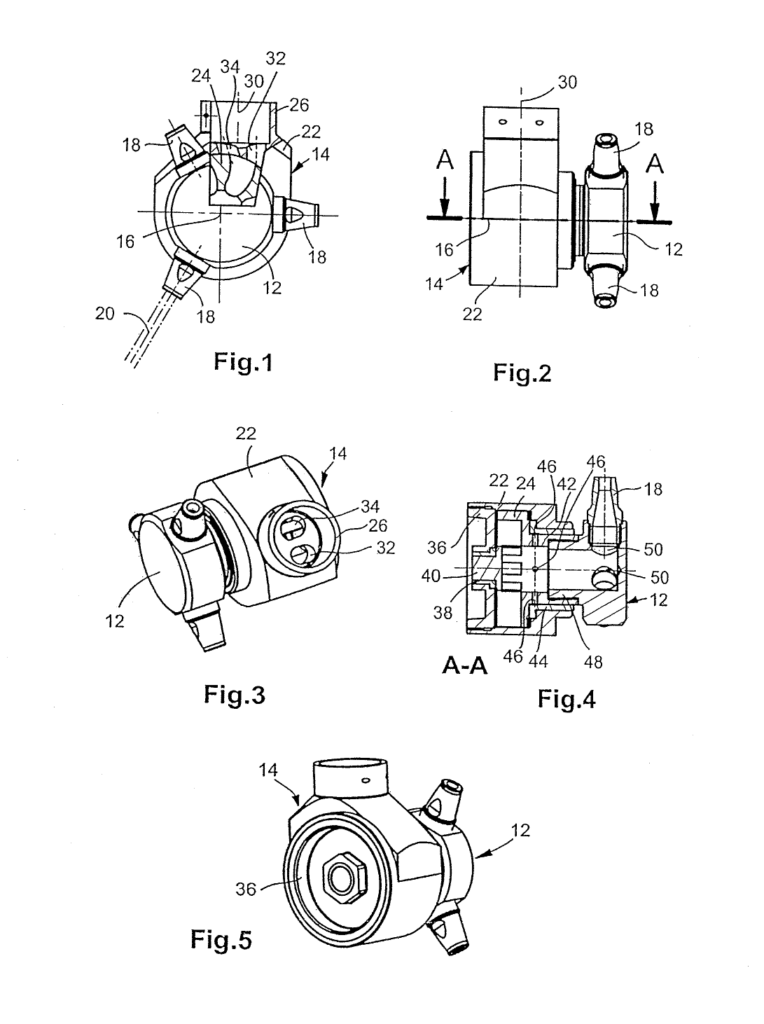

FIG. 1 shows a nozzle head 12 that is mounted for rotation on a first driving system 14 of which a partial cross-section is shown in FIG. 1. The first driving system 14 causes the nozzle head 12 to rotate about a first axis of rotation 16. On the nozzle head 12, there are disposed a total of three solid stream jet nozzles 18 which are oriented radially in relation to the first axis of rotation 16 and each of which during operation releases a solid stream jet 20 that is oriented radially in relation to the first axis of rotation 16.

Rotation of the nozzle head 12 is caused by means of a turbine wheel 24 mounted for rotation in a housing 22 of the first driving system 14. The turbine wheel 24 is coupled to the nozzle head 12 for rotation therewith and with no interposition of a gear mechanism. The turbine wheel 24 is directly driven by the fluid to be ejected, which is guided toward the turbine wheel 24 by means of a connecting flange 26 of the housing 22.

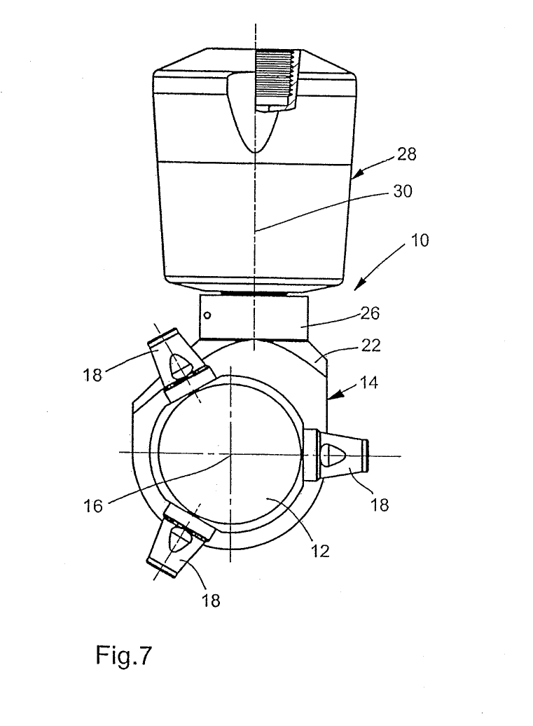

FIG. 7 shows a rotating nozzle system 10 of the invention comprising the first driving system 14 and the nozzle head 12. As mentioned above, the first driving system 14 causes the nozzle head 12 and the solid stream jet nozzles 18 disposed thereon to rotate about the first axis of rotation 16. The housing 22 of the first driving system 14 is connected by its inlet flange 26 to an output shaft of a second driving system 28 for rotation therewith. The second driving system 28 causes its output shaft and thus the housing 22 of the first driving system 14 to rotate about a second axis of rotation 30. As can be readily discerned from FIG. 7, the first axis of rotation 16 extends at right angles to the second axis of rotation 30. The second driving system 28 can be driven by electrical, pneumatic or hydraulic means and comprises, in the preferred embodiment illustrated, a turbine wheel (not shown in the figure) that is itself driven by the liquid to be ejected. The turbine wheel can be coupled to the output shaft by means of a planetary gear in order to achieve a desired rotational speed of the housing 22 of the first driving system 14 about the second axis of rotation 30.

The front view shown in FIG. 2 shows the housing 22 of the first driving system 14 and the nozzle head 12 that includes the solid stream jet nozzles 18 and that is disposed outside the housing 22. The first axis of rotation 16, about which the nozzle head 12 rotates, extends at right angles to the second axis of rotation 30 about which the housing 22 is rotated by means of the second driving system 28 (see FIG. 7). By superimposition of the rotational motion about the first axis of rotation 16 and about the second axis of rotation 30, the solid stream jets 20 emerging from the solid stream jet nozzles 18 can thus cover a large area and ensure, for example, thorough internal cleaning of a tank.

As can be seen from FIG. 2, the first driving system 14 and the nozzle head 12 are disposed so as to be directly adjacent to each other and they require very little space in the plane of the first axis of rotation 16. Thus the nozzle system 10 of the invention (see also FIG. 7), can be introduced, even together with the second driving system 28, into comparatively narrow tank orifices or cleaning hatches, if necessary.

FIG. 3 is a view, taken obliquely from above, of the first driving system 14 and the nozzle head 12. This view shows the inlet flange 26 of the housing 22 at the base of which two inlet ducts 32, 34 are visible. The fluid to be ejected flows through the inlet ducts 32, 34 into the interior of the housing 22 and toward the turbine wheel 24 (see also FIG. 1). As may be seen from the illustrations shown in FIG. 1 and in FIG. 3, the inlet ducts 32, 34 are not oriented in the radial direction. Rather, they are oriented such that each of their longitudinal center axes is oriented tangentially to the first axis of rotation 16. The diameter of a circle around the first axis of rotation 16 against which the longitudinal center axis of the first inlet duct 32 rests is greater than the diameter of a circle which is touched by the longitudinal center axis of the second inlet duct 34. Thus fluid discharged from the inlet ducts 32, 34 impacts the turbine wheel 24 at different angles, which ensures that the turbine wheel 24 has a high starting torque and, at the same time, operates at a steady speed once it has been set in motion.

The illustration shown in FIG. 4 is a view of the cross-sectional plane A-A indicated in FIG. 2. The housing 22 is generally annular in shape and is sealed in a liquid-tight manner on its surface shown in the left half of FIG. 4 by means of a pot-shaped cover 36. The pot-shaped cover 36 comprises at its center a bearing bore with a bearing bush 38 disposed therein. A bearing journal 40 of the turbine wheel 24 is disposed in this bearing bush 38. The turbine wheel 24 is in turn integrally connected to a hollow shaft 42 that extends from the turbine wheel 24 toward the nozzle head 12. The hollow shaft 42 is mounted for rotation in a bearing bush 44 on the housing 22. The bearing bush 44 and the hollow shaft 42 form a so-called hydrodynamic bearing. In all, four bores 46 are provided that extend in the radial direction proceeding from the interior of the hollow shaft 42 and allow fluid to be forced into a bearing gap between the bearing bush 44 and the hollow shaft 42, thus ensuring a substantially frictionless mounting of the hollow shaft 42 in the bearing bush 44.

The turbine wheel 24 is formed integrally with the hollow shaft 42 and bearing journal 40 and is supported on both sides in the housing 22. Thus a constant gap can be maintained during operation between the external periphery of the turbine wheel 24 and the internal periphery of a turbine chamber in the housing 22.

The individual blades of the turbine wheel 24 guide the fluid to be ejected into the interior of the hollow shaft 42.

As may be seen from FIG. 4, the nozzle head 12 comprises a laterally protruding tubular attachment 48 that is non-rotationally connected to the hollow shaft 42 for rotation therewith and is screwed into the same for this purpose at its free end. Thus fluid to be ejected flows from the connecting flange 46 of the housing 22 through the inlet ducts 32, 34 toward the turbine wheel 24 and through the space between the blades of the turbine wheel 24 into the interior of the hollow shaft 42. Thence the fluid to be ejected flows into the tubular attachment 48 of the nozzle head 12. Proceeding from the tubular attachment 48, the fluid to be ejected flows toward outlet ducts 50 extending radially from the interior of the nozzle head 12 and leading to the solid stream jet nozzles 18. As can be seen from the illustrations shown in FIG. 1, in FIG. 3, and in FIG. 4, the cross-sections of the inlet ducts 32, 34, the passages between the blades of the turbine wheel 24 and the outlet ducts 50 leading to the solid stream jet nozzles 18 have a large free cross-section so that the rotating nozzle system 10 of the invention is less susceptible to choking effects.

The illustration shown in FIG. 5 shows the first driving system 14 and the nozzle head 12 in a view taken obliquely from the rear. The figure shows the pot-shaped design of the cover 36 and the overall compact design of the first driving system 14 and nozzle head 12. A transverse dimension parallel to the first axis of rotation 16 of the first driving system 14 and the nozzle head 12 in the assembled state is approximately equal to the height of the first driving system 14 parallel to the second axis of rotation 30.

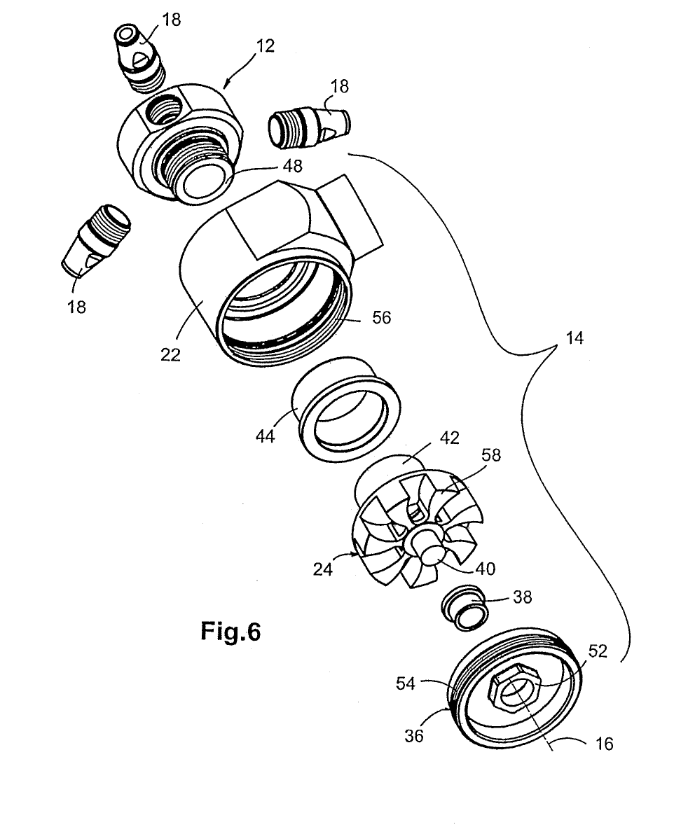

The illustration shown in FIG. 6 is an exploded view of the first driving system 14 and nozzle head 12 comprising the solid stream jet nozzles 18. The figure shows the tubular attachment 48 on the nozzle head 12 that is subsequently screwed into the hollow shaft 42 on the turbine wheel 24. The hollow shaft 42 is mounted in the generally annular housing 22 by way of the bearing bush 44. The bearing journal 40 remote from the hollow shaft 42 on the turbine wheel 24 is in turn mounted for rotation on the cover 36 by way of the bearing bush 38. A bore at the center of the cover 36 accommodates the bearing bush 38, which central bore is surrounded by a hexagon 52. Said hexagon 52 is used for screwing the cover 36 provided with a male screw thread 54 into a corresponding female screw thread 56 on the housing 22.

The turbine wheel 24 comprises a total of seven blades 58, between which fluid to be ejected flows into the interior of the hollow shaft 42. The turbine blades 58 have a constant cross-section, as regarded in the direction of the first axis of rotation 16 so that there are no undercuts and the turbine wheel 24 together with the bearing journal 40 and the hollow shaft 42 are easy to produce in the form of a turned, milled, or cast component.

1. A rotating nozzle system comprising a nozzle head and a first driving system for rotating said nozzle head about a first axis of rotation, wherein a second driving system is provided for rotating said nozzle head and said first driving system about a second axis of rotation, wherein said second axis of rotation is disposed substantially at right angles to said first axis of rotation.

2. The rotating nozzle system as defined in claim 1, wherein said nozzle head comprises a plurality of solid stream nozzles, each of which ejects a solid jet oriented substantially radially to said first axis of rotation.

3. The rotating nozzle system as defined in claim 1, wherein said first driving system comprises a housing and a turbine wheel disposed in said housing, wherein said turbine wheel and said nozzle head are non-rotatably connected to a hollow shaft mounted in said housing.

4. The rotating nozzle system as defined in claim 1, wherein said housing is connected to said second driving system.

5. The rotating nozzle system as defined in claim 1, wherein said housing is annular in shape.
